(19) United States
(12) Patent Application Publication
(10) Pub. No.: US 2002/0005821 A1
(43) Pub. Date: Jan. 17, 2002

(54) Electric sign board operating system and operating method thereof

(76) Inventor: John Park, Orlando, FL (US)

Correspondence Address: Allen, Dyer, Doppelt, Milbrath & Gilchrist, P.A., 255 South Orange Avenue, Suite 1401, P.O. Box 3791, Orlando, FL, 32802-3791, US

(21) Appl. No.: 09/800,269

(22) Filed: Mar. 6, 2001

Related U.S. Application Data
(60) Provisional application No. 60/218,330, filed on Jul. 14, 2000.

(51) Int. Cl. G09G 3/00

(52) U.S. Cl. 345/30

(57) ABSTRACT

An electric sign board operating system having an electric signal board operating computer, the electric signal board operating computer including: an input means for receiving an advertisement file to be displayed on an electric sign board through a network; a first storing means for storing the advertisement file; a second storing means, including an electric sign board operating program, for processing the advertisement file stored in the first storing means, generating an advertisement plan list and storing it in the first storing means; an output means for transmitting the advertisement file and a control signal for the electric sign board; and a CPU for executing the electric sign board operating program to generate the advertisement plan list and the control signal. With this system, receiving and displaying of a plurality of advertisements thereby effectively managed with respect to a plurality of electric sign boards.

### CROSS-REFERENCE TO RELATED APPLICATIONS

This application claims priority to and incorporates by reference co-pending application Ser. No. 60/218,330, filed Jul. 14, 2000, commonly owned with the present application.

### FIELD OF THE INVENTION

The present invention relates to an electric sign board operating system and method, and more particularly to an electric sign board operating system and method which include an electric sign board operating program for receiving an advertisement file and an advertisement reception data through the Internet and generating an advertisement plan list, thereby effectively managing, receiving, and displaying of a plurality of advertisements with respect to a plurality of electric sign boards.

### BACKGROUND

A conventional electric sign board system roughly includes two behaviors: one where a manager separately manages advertisement data by receiving the advertisement data directly from an advertisement client and displaying it on each electric sign board, and the other where the manager transmits the advertisement data to be displayed on each electric sign board through a wired or a wireless advertisement system.

FIG. 1A is a schematic view showing a construction of a remote area and local area controlling radio advertisement system 1, which includes a remote area message input unit 10 using a radio communication terminal 11 such as a cellular phone or a PCS phone and a personal computer (PC) 12; a PC communication network 20 for connecting communication of the PC 12; a general radio communication network 30 for transmitting radio message information received from the remote area message input unit 10 and the PC communication network 20 to electric sign board systems scattered in the remote areas. An electric sign board system 100 is installed at each remote area for receiving the message transmitted through the radio communication network 30 and displaying it. The electric sign board system 100 permits input and correction of a message directly. A message transmission managing server 40 is connected with the PC communication network 20 and with the radio communication network 30 for receiving and transmitting the message from and to the remote area message input unit 10, and displaying method of the message on each electric sign board system 100, correcting or deleting the message.

The message transmission managing server 40 manages and controls in a manner that it receives text messages from the remote area message input unit 10, classify them by groups requiring the electric sign boards which are dispersedly located in the remote areas, calls collectively the input messages of the remote area message input unit 10 by groups according to a corresponding message request through the radio communication network, and transmits the corresponding message.

Meanwhile, in case of constructing additionally an independent server connected through the PC communication network (the Internet), a signal of the radio communication terminal 11 such as the cellular phone is inputted through the radio communication network 30 to the managing server 40, the input data of the PC 12 is inputted through the PC communication network 20 to the managing server 40, and the managing server 40 processes the message and transmits it through the radio communication network 30 to the electric sign board system 100.

FIG. 1B is a schematic block diagram of the electric sign board system 100, which includes a radio receiving unit 110 which is set to receive a radio signal, for receiving a message; a display control unit 120 having a demodulator 121 for receiving a receiving signal of the radio receiving unit 110 and a remote controller receiving unit 152 and demodulating it to a text message, a storing unit 122 for storing the text message signal demodulated by the demodulator 121, and an editing and displaying controller 123 for recognizing an identification signal for statement control command among the demodulating signals of the demodulator 121, editing the text message stored in the storing unit 122 to a statement to be displayed, and controlling the display order and display method of the messages to be displayed; an electric sign board drive unit 130 for displaying the text message under the control of the display control unit 120; an LED electric sign board 140; and a remote controller input unit 150 having a remote controller 151 for correcting and receiving a text, and a remote controller receiving unit 152 for receiving a signal of a remote controller 151 and transmitting it to the display control unit 120 to correct or insert a content of the electric sign board.

In a conventional radio advertisement system, a text message may be transmitted through a cellular phone or the PC communication network to an electric sign board system with the text message including an identification signal linking the starting point and the ending point thereof and an identification signal for informing the ending point of the message. Typically, a code system for repetition, order and time of a statement is pre-determined. When the text message is transmitted through a PC communication network, its code information for a display method is also transmitted, so that the electric sign board system 100 can analyze the corresponding code, determine accordingly a display method of the received statement, thereby controlling the electric sign board. Numerous advertisement messages are repeated in a proper order and a desired message is displayed.

In managing and operating the plurality of electric sign boards, in situations where the manager manages the electric sign boards separately, a considerable time and expense are consumed to receive an advertisement requested by an advertisement client and display it, as well as having a difficulty in managing effectively each electric sign board.

Meanwhile, while an operating system using the radio advertisement system has a favorable function with respect to transmission of the text message of the advertisement displayed on the electric sign board, it does not have a function to receive and process a commercial video and an audio advertisement. Such a need is often identified so that the commercial video and the audio advertisement are not possibly transmitted to the electric sign board drive unit. In other words, the operating system is incapable of managing of receiving, storing and displaying the commercial video and audio advertisement, collectively.

In addition, though it is known to control editing and displaying of an advertisement to be displayed on the electric sign board, disturbance occurs frequently with the electric sign board drive unit or the electric sign board itself. In this respect, no solution has been proposed to date that satisfied a need for having an advertisement transmitted from a storing unit and not being displayed.

### SUMMARY OF THE INVENTION

Therefore, an object of the present invention is to provide a system and method for receiving a video or an audio advertisement through the Internet and displaying it on an electric sign board of a site and at a time desired by an advertisement client.

Another object of the present invention is to provide an electric sign board operating program which is capable of making a list for advertisements displayed on every electric sign board and accordingly managing it.

Still another object of the present invention is to provide an electric sign board operating method which is capable of making a list for advertisement actually displayed on a plurality of electric sign boards and managing it, thereby offering the client a rational management with respect to the advertisement fee.

To achieve these and other advantages and in accordance with the purpose of the present invention, as embodied and broadly described herein, there is provided an electric sign board operating system having an electric signal board operating computer, the electric signal board operating computer including: an input means for receiving an advertisement file to be displayed on an electric sign board through a network; a first storing means for storing the advertisement file; a second storing means, including an electric sign board operating program, for processing the advertisement file stored in the first storing means, generating an advertisement plan list and storing it in the first storing means; an output means for transmitting the advertisement file and a control signal for the electric sign board; and a CPU for executing the electric sign board operating program to generate the advertisement plan list and the control signal.

In order to achieve the above objects, there is also provided an electric sign board operating method of an electric sign board operating system having an electric sign board control means for controlling an electric sign board and an electric sign board operating computer for transmitting an advertisement file and a control signal to the electric sign board control means, including the steps of: receiving and storing an advertisement file by the electric sign board operating computer; receiving and storing an advertisement reception data by the electric sign board operating computer; making an advertisement plan list including the inputted advertisement file and the advertisement reception data and storing it; and displaying the advertisement file according to the advertisement plan list.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention, wherein:

FIG. 1A is a schematic view of a construction of a remote area and local area controlling radio advertisement system in accordance with a conventional art;

FIG. 1B is a schematic block diagram of an electric sign board system in accordance with the conventional art;

FIG. 2 illustrates a construction of an electric sign board operating system in accordance with the present invention;

FIG. 3A illustrates a construction of an electric sign board operating room computer 22 or an electric sign board operating computers 23-1 through 23-N of FIG. 2 in accordance with the present invention;

FIG. 3B illustrates a construction of the first electric sign board 23-11 through the ‘L’th electric sign board (23-NL) of FIG. 2 in accordance with the present invention;

FIG. 4 illustrates data structure of an advertisement plan list in accordance with the present invention;

FIG. 5A is a flow chart of an electric sign board operating method of the electric sign board operating room computer 21 in accordance with the present invention;

FIG. 5B is a flow chart of an electric sign board operating method of the electric sign board operating computers 23-1 through 23-N in accordance with the present invention; and

FIG. 5C is a flow chart of displaying an advertisement in accordance with the present invention.

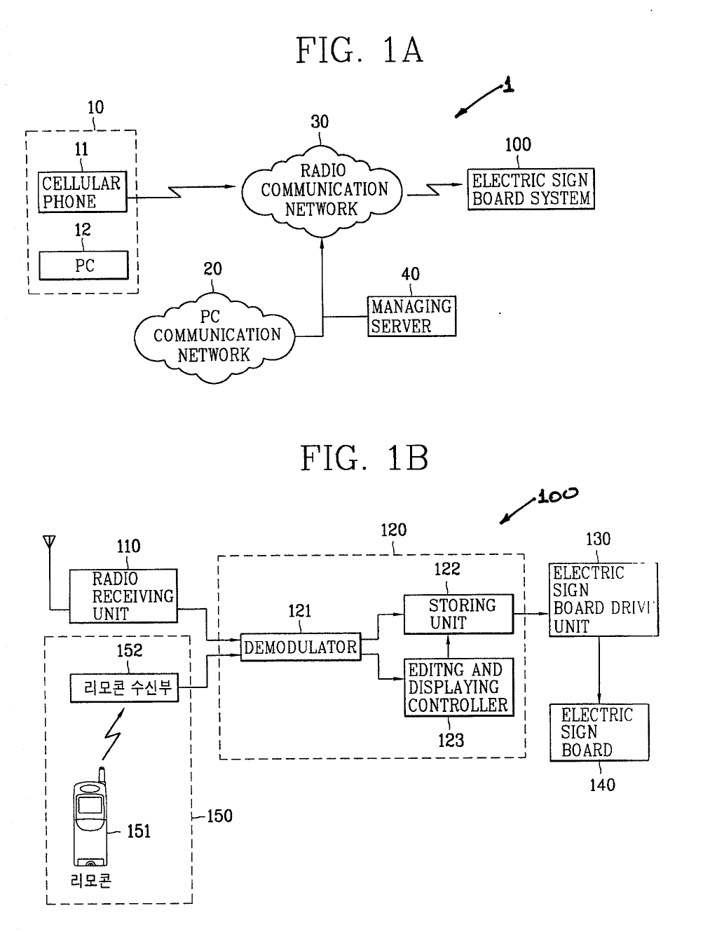

### DETAILED DESCRIPTION OF PREFERRED EMBODIMENTS

Reference will now be made in detail to preferred embodiments of the present invention, examples of which are illustrated in the accompanying drawings.

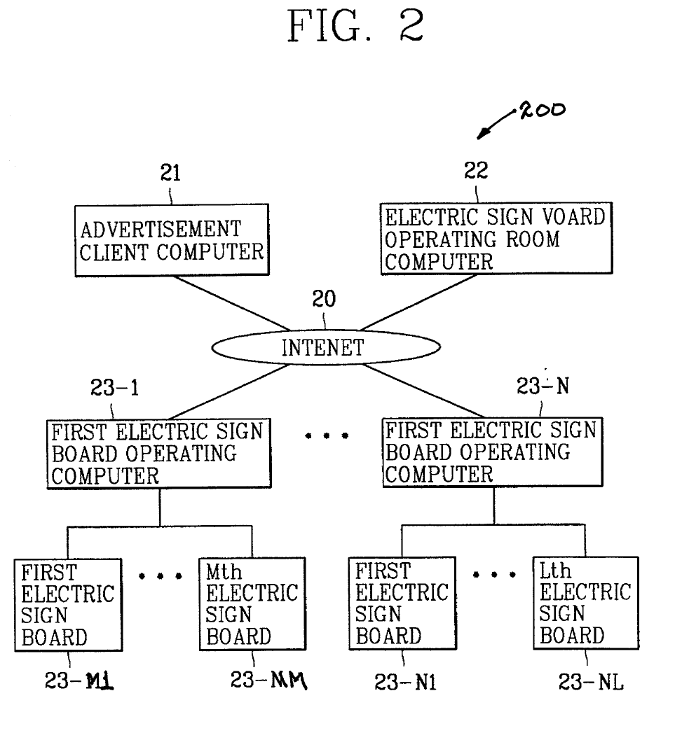

FIG. 2 illustrates a construction of an electric sign board operating system 200 in accordance with the present invention. As shown in the drawing, the electric sign board operating system 200 includes the Internet 20; an electric sign board operating room computer 22 for transmitting various data through the Internet 20 and controlling an operating computer 23 connected with the Internet; a client computer 21 for displaying an advertisement; a first to an Nth electric sign board operating computers 23-1 to 23-N for receiving the data from the client computer 21 or from the electric sign board operating room computer 22; and a first to an Mth electric sign boards controlled by the first electric sign board operating computer 23-1 and a first to an Lth electric sign boards 23-N1 to 23-NL controlled by the Nth electric sign board operating computer.

The client computer 21 transmits through the Internet an advertisement file and an advertisement reception data to the electric sign board operating room computer 22 or to the first electric sign board operating computer 23-1 through the Nth electric sign board operating computer 23-N.

The advertisement file designates a data form including a text, an image, a mobile image or a sound to be displayed on the electric sign board. The advertisement reception data designates a data form including an advertisement client, an advertisement display term, an advertisement display time and an advertisement display spot, of which the advertisement client may be the name of a person who requests displaying of an advertisement, the advertisement display term may be from Dec. 10, 2000 to Dec. 29, 2000, by way of example, the advertisement display time may be from 30 minutes to 33 minutes of every hour, and the advertisement display spot may be every electric sign board of a specific area or a specific electric sign board.

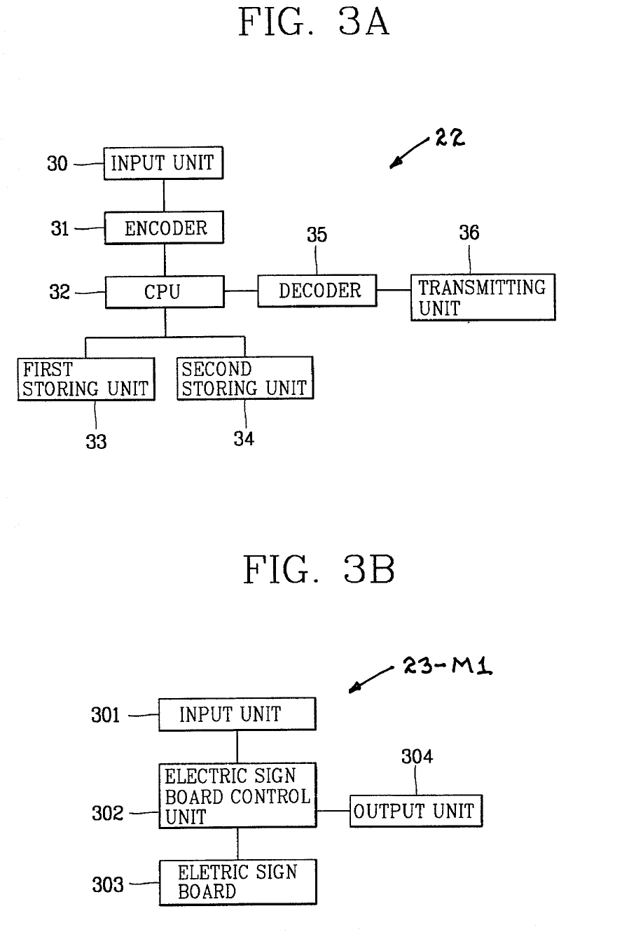

FIG. 3A illustrates a construction of an electric sign board operating room computer 22 or any of an electric sign board operating computer 23-1 through 23-N in accordance with the present invention, which includes an input unit 30 for receiving the advertisement file or the advertisement reception data transmitted through the Internet 20 from the advertisement client computer 21; an encoder 31 for compressing the advertisement file; a CPU 32 for receiving and processing the compressed advertisement file and the advertisement reception data; a first storing unit 33 for storing the advertisement file and the advertisement reception data; a second storing unit 34 for processing the advertisement file and the advertisement reception data stored in the first storing unit, generating an advertisement plan list and storing a program; a decoder 35 for decompressing the advertisement file; and a transmitting unit 36 for transmitting a control signal for the advertisement file and the electric sign board.

The advertisement file is inputted in a compressed file, that is, for example, in an MPEG-2 file form, and in case that the advertisement file is not in the MPEG-2 file form, it is converted to the MPEG-2 file form through the encoder 31, which can be retrieved to the original advertisement form through the decoder 35.

FIG. 3B illustrates a construction of the first electric sign board 23-11 through the ‘L’th electric sign board (23-NL) in accordance with the present invention, which includes an input unit 301 for receiving the advertisement file and the control signal from the first to the Nth electric sign board operating computers 23-1 to 23-N; an electric sign board control unit 302 for displaying the advertisement file on the electric sign board and receiving the control signal; an electric sign board 303 for displaying the advertisement file and being operated according to the control signal; and an output unit 304 for transmitting whether the advertisement file is displayed on the electric sign board control unit 302 and the state of the electric sign board.

The CPU 32 of the electric sign board operating room computer 22 or of the electric sign board operating computers 23-1 to 23-N executes the electric sign board operating room program or the electric sign board operating program stored in the second storing unit to make the advertisement plan list including the advertisement file and the advertisement reception data and stores the advertisement plan list in the second storing unit.

The advertisement plan list is a data, consisting of the advertisement file and the advertisement reception data, that the advertisement file is classified depending on the advertisement display spot (or the electric sign board) and sorted in an order of the advertisement display term and the advertisement display time.

When there is no advertisement plan list stored in the second storing unit, the CPU 32 generates an advertisement plan list. When there is an advertisement plan list in the second storing unit, the CPU 32 updates it by deleting the advertisement file of which an advertisement display term and an advertisement display time has passed. Further, advertisement reception data, a new advertisement file, and advertisement reception data are added, thereby making a new advertisement plan list.

The electric sign board operating room computer 22 receives an advertisement file and an advertisement reception data from the advertisement client computer 21, makes an advertisement plan list, and transmits the advertisement file and the advertisement reception data to one of the first to the Nth electric sign board operating computers 23-1 to 23-N according to the advertisement plan list.

Upon receipt of the advertisement plan list, the electric sign board operating computer generates a new advertisement plan list by additionally including the advertisement file and the advertisement reception data included in the transmitted advertisement plan list, in the advertisement plan list stored in the second storing unit, by using the electric sign board operating program.

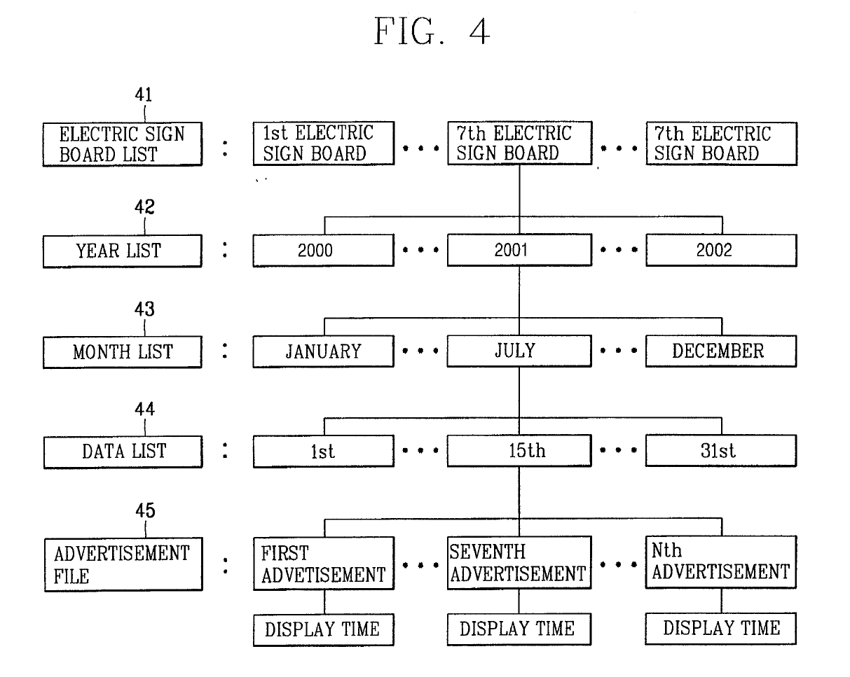

FIG. 4 illustrates data structure of an advertisement plan list in accordance with the present invention, which includes an electric sign board list (or an advertisement display spot) 41, a year list 42, a month list 43, a date list 44 and an advertisement file 45.

After the electric sign board operating computers 23-1 to 23-N and the operating sign board operating room computer 22 receive the advertisement file, the advertisement display term, the advertisement display time and the advertisement display spot from the advertisement client computer 21, they execute the electric sign board operating program and the electric sign board operating room program, respectively, classify the advertisement file according to the advertisement display spot (or the electric sign board), and classify minutely the advertisement file according to the advertisement display term and the advertisement display time, thereby making an advertisement plan list.

On the basis of the advertisement plan list, the electric sign board operating computers 23-1 to 23-N transmit the advertisement file to the first to the Lth electric sign boards 23-11 to 23-NL.

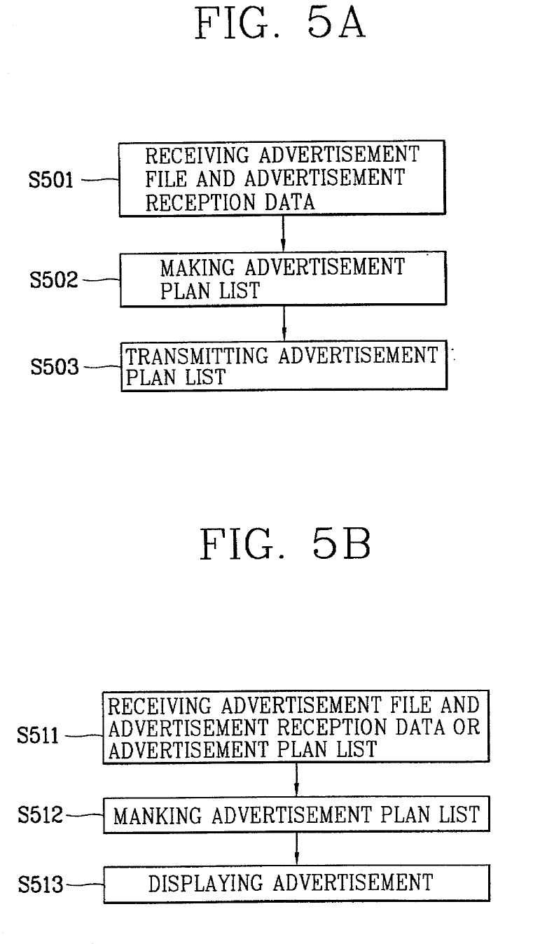

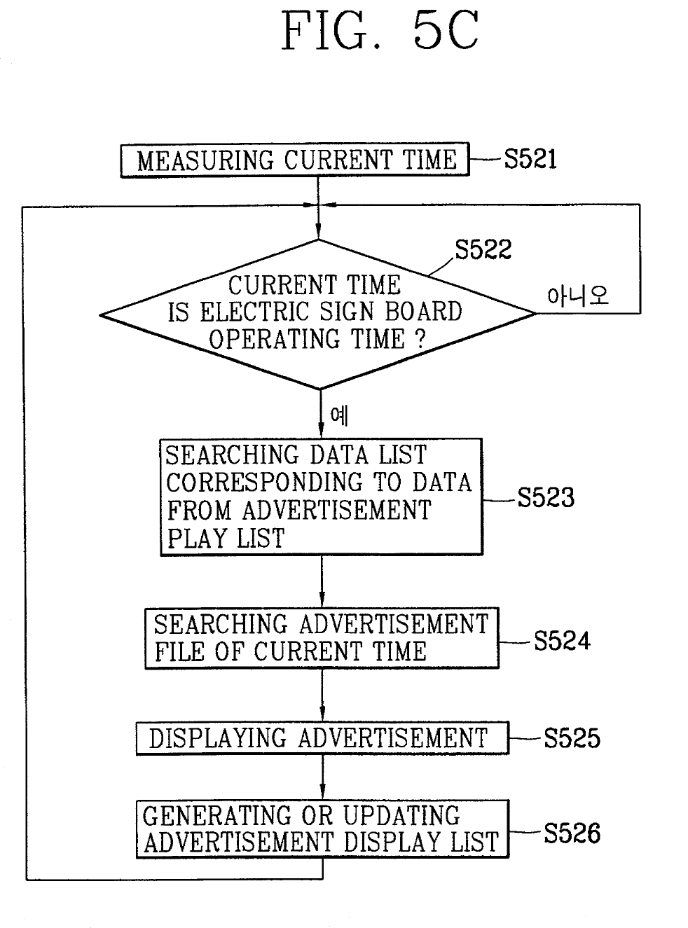

FIG. 5A is a flow chart of an electric sign board operating method of the electric sign board operating room computer 21 in accordance with the present invention.

As shown in the drawing, the electric sign board operating method includes: a step S501 of receiving an advertisement file and an advertisement data S501, a step S502 of making an advertisement plan list, and a step S503 of transmitting the advertisement plan list. These steps have been explained in detail in the above descriptions.

FIG. 5B is a flow chart of an electric sign board operating method of the electric sign board operating computers 23-1 through 23-N in accordance with the present invention.

As shown in the drawing, the electric sign board operating method of the electric sign board operating computers 23-1 through 23-N includes: a step S511 of receiving an advertisement file and an advertisement reception data or an advertisement plan list; a step S512 of making an advertisement plan list; and a step S513 of displaying an advertisement. The steps S511 and S512 have been explained in the above descriptions, while the step S513 will be described hereinafter.

FIG. 5C is a flow chart of displaying an advertisement in accordance with the present invention.

As shown in the drawing, the displaying an advertisement includes the step S521 of measuring the current time; a step of S522 of judging whether the current time is in the range of the electric sign board operating time; a step S523 of searching a date list corresponding to the current date from the advertisement plan list; a step S524 of searching an advertisement file of the current time; a step S525 of transmitting the advertisement file; and a step S526 of generating a new advertisement display list or updating the existing advertisement display list.

In detail, in the step S521, the current time is measured on the basis of the system time of the electric sign board operating computers 23-1 to 23-N.

In the step S522, since there may be a case that an operating time of the electric sign board is specified, it is judged whether the current time is in the range of the electric sign board operating time.

Upon judgment, in case that the current time is not included in the range of the electric sign board operating time, it returns to the step S521. Meanwhile, in case that the current time is in the range of the electric sign board operating time, a date list corresponding to the current date is searched from the advertisement plan list in the step S523, and an advertisement file corresponding to the current time is searched from the corresponding advertisement plan list in the step S524.

The electric sign board operating computers 23-1 to 23-N transmits the advertisement file to the input unit 301 of the first to the Lth electric sign boards 23-11 to 23-NL, and the electric sign board control unit 302 transmits the advertisement file to the electric sign board 303, so as to be displayed (S525).

After the electric sign board operating computers 23-1 to 23-N transmits the advertisement file in the step S526, the advertisement display list including the advertisement client, the advertisement file and the number of times of advertisement display updated or a new one is generated.

That is, in case that the advertisement file transmitted from the advertisement client is first displayed, the electric sign board control unit 302 transmits a signal signifying that the advertisement has been displayed to the electric sign board operating computers 23-1 to 23-N. Then, the electric sign board operating computers 23-1 to 23-N generate an advertisement display list including the number of times of the display of the advertisement for the advertisement file on the basis of the signal and store it in the first storing unit. In this respect, in case that there exists an advertisement display list in the first storing unit, the existing advertisement display list is updated and stored.

By virtue of the advertisement display list, the number of times that the advertisement file requested by the advertisement client has been displayed on the first sign board 23-11 to the Lth electric sign board 23-NL can be accurately computed.

As so far described, the electric sign board operating system and method of the present invention has the following effect.

That is, first, as a request for an advertisement is received in the file form of a video or an audio, the advertisement is displayed on an electric sign board (one or more) and at a time desired by the client.

Secondly, since the electric sign board operating room computer and the electric sign board operating computer execute the electric sign board operating room program and the electric sign board operating program, respectively, they generate and store the advertisement plan list to be displayed on every electric sign board and the advertisement display list that has been already displayed on the electric sign board, so that the advertisement can be effectively displayed and a reliability for the display of the advertisement can be improved.

Lastly, the advertisement display list contributes to a rational and proper billing for the advertisement fee for the sake of the client and its management.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. An electric sign board operating system having an electric signal board operating computer, said electric signal board operating computer comprising:
an input means for receiving an advertisement file to be displayed on an electric sign board through a network;
a first storing means for storing the advertisement file;
a second storing means, including an electric sign board operating program, for processing the advertisement file stored in the first storing means, generating an advertisement plan list and storing it in the first storing means;
an output means for transmitting the advertisement file and a control signal for the electric sign board; and
a CPU for executing the electric sign board operating program to generate the advertisement plan list and the control signal.

2. The system according to claim 1, further comprising an electric signal board control means for receiving the advertisement file and the control signal and displaying an advertisement on the electric sign board.

3. The system according to claim 1, wherein the electric sign board operating computer receives an advertisement reception data through the input means and stores it in the first storing means.

4. The system according to claim 3, wherein the advertisement reception data includes an advertisement client, an advertisement display term, an advertisement display time and an advertisement display spot.

5. The system according to claim 1, wherein the electric sign board operating program classifies the advertisement file according to the advertisement display spot, makes an advertisement plan list sorted in an order of the advertisement display term and the advertisement display time, and stores the advertisement plan list in the first storing means.

6. The system according to claim 5, wherein the electric sign board operating program reads the advertisement plan list previously stored in the first storing means, adds the inputted advertisement file and the advertisement reception data, and makes a new advertisement plan list.

7. The system according to claim 6, wherein the electric sign board operating program deletes an advertisement file and an advertisement reception data of which an advertisement display term and an advertisement display time have passed, from the previously stored advertisement plan list, and makes a new advertisement plan list.

8. The system according to claim 1, wherein the electric sign board operating program makes an advertisement display list by additionally including the number of times that the advertisement file transmitted from the electric sign board operating computer has been displayed on the electric sign board by means of the electric sign board control means.

9. An electric sign board operating system having an electric sign board operating room computer, said electric sign board operating room computer comprising:
an input means for receiving an advertisement file to be displayed on an electric sign board through a network;
a first storing means for storing the advertisement file received from the input means;
a second storing means having an electric sign board operating room program for processing the advertisement file stored in the first storing means, making an advertisement plan list and storing it in the first storing means;
an output means for transmitting the advertisement plan list through the network; and
a CPU for executing the electric sign board operating room program and making the advertisement file list.

10. The system according to claim 9, wherein the electric sign board operating room computer transmits the advertisement plan list to an electric sign board operating computer connected with an electric sign board control means which controls the electric sign board.

11. The system according to claim 9, wherein the electric sign board operating room computer receives an advertisement reception data through the input means and stores it in the first storing means.

12. The system according to claim 11, wherein the advertisement reception data includes an advertisement client, an advertisement display term, an advertisement display time and an advertisement display spot.

13. The system according to claim 9, wherein the electric sign board operating program classifies the advertisement file according to the advertisement display spot, makes an advertisement plan list sorted in an order of the advertisement display term and the advertisement display time, and stores the advertisement plan list in the second storing means.

14. The system according to claim 13, wherein the electric sign board operating room program reads the advertisement plan list previously stored in the second storing means, adds the inputted advertisement file and the advertisement reception data, and makes a new advertisement plan list.

15. The system according to claim 14, wherein the electric sign board operating room program deletes an advertisement file and an advertisement reception data of which an advertisement display term and an advertisement display time have passed, from the previously stored advertisement plan list, and makes a new advertisement plan list.

16. An electric sign board operating system including an electric sign board operating computer and an electric sign board operating room computer, of which said electric sign board operating computer comprising:
a first input means for receiving an advertisement file to be displayed on an electric sign board through a network;
a first storing means for storing the advertisement file;
a second storing means having an electric sign board operating program for processing the advertisement file stored in the first storing means, generating an advertisement plan list, and storing the generated advertisement plan list in the first storing means;
a first input means for transmitting the advertisement file and a control signal for the electric sign board; and
a first CPU for executing the electric sign board operating program to generate the advertisement plan list and the control signal; and
said electric sign board operating room computer comprising:
a second input means for receiving an advertisement file to be displayed on the electric sign board through the network;
a third storing means for storing the advertisement file received from the input means;
a fourth storing means having an electric sign board operating room program for processing the advertisement file stored in the third storing means, making an advertisement plan list, and storing it in the third storing means;
a second output means for transmitting the advertisement plan list through the network; and
a second CPU for executing the electric sign board operating room program and making the advertisement file list.

17. The system according to claim 16, further comprising an electric signal board control means for receiving the advertisement file and the control signal and displaying an advertisement on the electric sign board.

18. The system according to claim 16, wherein the electric sign board operating computer and the electric sign board operating room computer receive an advertisement reception data through the first input means and the second input means, and store it in the first and the third storing means, respectively.

19. The system according to claim 18, wherein the advertisement reception data includes an advertisement client, an advertisement display term, an advertisement display time and an advertisement display spot.

20. The system according to claim 16, wherein the electric sign board operating program and the electric sign board operating room program classify the advertisement file according to the advertisement display spot, make an advertisement plan list sorted in an order of the advertisement display term and the advertisement display time, and store the advertisement plan list in the first and the third storing means, respectively.

21. The system according to claim 20, wherein the electric sign board operating program and the electric sign board operating room program read the advertisement plan list previously stored in the first and the third storing means, add the inputted advertisement file and the advertisement reception data, and make a new advertisement plan list, respectively.

22. The system according to claim 21, wherein the electric sign board operating program and the electric sign board operating room program delete an advertisement file and an advertisement reception data of which an advertisement display term and an advertisement display time have passed, from the previously stored advertisement plan list, and make a new advertisement plan list, respectively.

23. The system according to claim 16, the electric sign board operating room computer transmits an advertisement plan list for the electric sign board control means controlled by a predetermined electric sign board operating computer among the advertisement plan list, to the electric sign board computer.

24. The system according to claim 23, wherein the electric sign board operating computer makes a new advertisement plan list including the received advertisement plan list.

25. The system according to claim 16, wherein the electric sign board operating computer transmits the advertisement plan list to the electric sign board operating room computer upon receipt of a request by the electric sign board operating room computer.

26. The system according to claim 25, wherein the electric sign board operating room computer makes a new advertisement plan list including the transmitted advertisement plan list.

27. The system according to claim 16, wherein the electric sign board operating program makes an advertisement display list by additionally including the number of times that the advertisement file transmitted from the electric sign board operating computer has been displayed on the electric sign board by means of the electric sign board control means.

28. The system according to claim 16, wherein the advertisement file is an MPEG-2.

29. The system according to claim 16, wherein the electric sign board operating system additionally includes an MPEG-2 encoder for converting the advertisement file to an MPEG-2 file.

30. The system according to claim 16, wherein the electric sign board operating system additionally includes an MPEG-2 decoder for converting the advertisement file to a video signal.

31. An electric sign board operating method of an electric sign board operating system having an electric sign board control means for controlling an electric sign board and an electric sign board operating computer for transmitting an advertisement file and a control signal to the electric sign board control means, comprising the steps of:
receiving and storing an advertisement file by the electric sign board operating computer;
receiving and storing an advertisement reception data by the electric sign board operating computer;
making an advertisement plan list including the inputted advertisement file and the advertisement reception data and storing it; and
displaying the advertisement file according to the advertisement plan list.

32. The method according to claim 31, wherein the advertisement file is in a compressed file form.

33. The method according to claim 31, wherein the advertisement reception data includes a selection of an electric sign board on which an advertisement is to be displayed, an advertisement client, an advertisement display term, an advertisement display time and the number of displaying an advertisement.

34. The method according to claim 33, wherein the advertisement plan list is made in a manner that the advertisement file is classified according to the electric sign board as selected in advertisement reception data and the classified advertisement file is sorted in the order of the advertisement display term and the advertisement display time.

35. The method according to claim 31, wherein the advertisement displaying step comprising the sub-steps of:
computing the current date by the electric sign board operating computer;
searching an advertisement file corresponding to the current date from the advertisement plan list; and
converting the searched advertisement file to a video signal and transmitting it to the electric sign board control means.

36. The method according to claim 35, wherein an advertisement display list is made including the advertisement file displayed on the electric sign board after being transmitted to the electric sign board control means.

37. The method according to claim 31, further comprising a step of decompressing the advertisement file and converting the decompressed advertisement file to a video file.

38. The method according to claim 34, wherein the advertisement plan list is made by reading the previously stored advertisement plan list and adding the inputted advertisement file and the advertisement reception data.

39. The method according to claim 34, wherein the advertisement plan list is made by deleting an advertisement file and an advertisement reception data of which an advertisement display term and an advertisement display time have passed, from the previously stored advertisement plan list.

40. An electric sign board operating method of an electric sign board operating system having an electric signal board operating room computer connected with an electric signal board operating computer, comprising the steps of:
receiving an advertisement file by the electric sign board operating room computer;
receiving an advertisement reception data by the electric sign board operating room computer;
making an advertisement plan list including the inputted advertisement file and the advertisement reception data; and
transmitting the advertisement plan list to the electric sign board operating computer.

41. The method according to claim 40, wherein the advertisement file is in a compressed file form.

42. The method according to claim 40, wherein the advertisement reception data includes a selection of an electric sign board on which an advertisement is to be displayed, an advertisement client, an advertisement display term, an advertisement display time and the number of displaying an advertisement.

43. The method according to claim 42, wherein the advertisement plan list is made in a manner that the advertisement file is classified according to the electric sign board as selected in advertisement reception data and the classified advertisement file is sorted in the order of the advertisement display term and the advertisement display time.

44. The method according to claim 40, wherein, in the transmitting step, the electric sign board operating room computer transmits the advertisement plan list corresponding to the electric sign board operating computer at predetermined time intervals.

45. The method according to claim 40, further comprising a step of decompressing the advertisement file and converting the decompressed advertisement file to a video file.

46. The method according to claim 44, wherein the advertisement plan list is made by reading the previously stored advertisement plan list and adding the inputted advertisement file and the advertisement reception data.

47. An electric sign board operating method of an electric sign board operating system having an electric sign board control means for controlling an electric sign board, an electric sign board operating computer for transmitting an advertisement file and a control signal to the electric sign board control means, and an electric sign board operating room computer connected with the electric sign board operating computer, comprising the steps of:
receiving and storing an advertisement file by the electric sign board operating computer and the electric sign board operating room computer, respectively;
receiving and storing an advertisement reception data by the electric sign board operating computer and the electric sign board operating room computer, respectively;
making an advertisement plan list including the inputted advertisement file and the advertisement reception data and storing it by the electric sign board operating computer and the electric sign board operating room computer, respectively; and
displaying the advertisement file according to the advertisement plan list made by the electric sign board operating computer.

48. The method according to claim 47, wherein the advertisement reception data includes a selection of an electric sign board on which an advertisement is to be displayed, an advertisement client, an advertisement display term, an advertisement display time and the number of displaying an advertisement.

49. The method according to claim 48, wherein the advertisement plan list is made in a manner that the advertisement file is classified according to the electric sign board as selected in advertisement reception data and the classified advertisement file is sorted in the order of the advertisement display term and the advertisement display time.

50. The method according to claim 49, wherein the advertisement plan list made by the electric sign board operating room computer is transmitted to the electric sign board operating computer connected with the electric sign board control means which controls the electric sign board.

51. The method according to claim 48, wherein the advertisement plan list made by the electric sign board operating computer is transmitted to the electric sign board operating room computer.

52. The method according to claim 51, wherein the electric sign board operating room computer makes a new advertisement plan list by adding the received advertisement plan list and stores it.

53. The method according to claim 47, wherein the advertisement displaying step comprising the sub-steps of:
computing the current date by the electric sign board operating computer;
searching an advertisement file corresponding to the current date from the advertisement plan list; and
converting the searched advertisement file to a video signal and transmitting the video signal to the electric sign board control means.

54. The method according to claim 53, wherein an advertisement display list is made including the advertisement file displayed on the electric sign board after being transmitted to the electric sign board control means.

55. The method according to claim 49, wherein the advertisement plan list is made by reading the previously stored advertisement plan list and adding the inputted advertisement file and the advertisement reception data.

56. The method according to claim 49, wherein the advertisement plan list is made by deleting an advertisement file and an advertisement reception data of which an advertisement display term and an advertisement display time have passed, from the previously stored advertisement plan list.

57. The method according to claim 47, wherein the step of receiving and storing the advertisement file comprising a sub-step of converting the advertisement file to a compressed file.

58. The method according to claim 47, further comprising a step of converting the advertisement file to a video file and transmitting the video file to the electric sign board control means.
